(19) United States
(12) Patent Application Publication
(10) Pub. No.: US 2012/0260592 A1
(43) Pub. Date: Oct. 18, 2012

(54) FOUNDATION FIXING UNIT, WIND ENERGY CONVERTER, AND METHOD FOR FIXING A TOWER OF A WIND ENERGY CONVERTER ONTO A FOUNDATION

(75) Inventor: Anton Wolf, Viktring (AT)

(73) Assignee: AMSC Windtec GmbH, Klagenfurt (AT)

(21) Appl. No.: 12/921,184

(22) PCT Filed: Oct. 22, 2009
(86) PCT No.: PCT/EP2009/063919

§ 371 Date: Sep. 7, 2010

(51) Int. Cl. E02D 27/42; E04B 1/38; E02D 27/32; B23P 11/00

(52) U.S. Cl. 52/296; 29/428; 29/525.02; 52/698; 52/292; 52/745.21

(57) ABSTRACT

Some general aspects of the invention provide a foundation fixing unit (202, 204, 400) for fixing a tower (108) of a wind energy converter (100) onto a foundation (110). The unit comprises a fixation plate (202) fixable to the foundation (110), walls forming at least one tower fixation hole (300) in the intermediate plate (202) for passing a tower fixation bolt (220) through the fixation plate (202) in order to fix the tower (108) to the fixation plate (202), a tower fixation nut (400) arranged below the at least one tower fixation hole (300) for receiving a threaded portion of the tower fixation bolt (220) and a nut cage (204) holding the tower fixation nut (400), the nut cage (204) being attached to a bottom surface (222) of the fixation plate (202). Under further aspects, the invention provides a wind energy converter tower comprising the foundation fixing unit (202, 204, 400) and a method for fixing a wind energy converter tower onto a foundation.

### BACKGROUND

The present invention relates to a foundation fixing unit for fixing a tower of a wind energy converter onto a foundation, to a corresponding method for fixing a tower of a wind energy converter onto a foundation, and to a wind energy converter.

Wind energy can be converted into useful forms, such as electricity, by a wind energy converter that generally includes a rotor, e.g. a low-speed propeller, coupled to a generator. Typically, wind energy converters include a tower comprising a tubular steel, concrete or mixed construction, which is fixed to an associated foundation, and, on the upper end of the tower, a rotary arrangement such as a nacelle, which bears the rotor and generator and is configured for rotation into the respective wind direction.

For towers of wind energy converters it is common to use anchor bolt connections for the fixation of the tower at the foundation. For example, when casting a concrete foundation, bolts are partially embedded in the wet concrete as cast-in-place anchor bolts, a threaded end of each anchor bolt left protruding upwardly from a top surface of the foundation. After the concrete has hardened, the threaded ends are guided through corresponding fixing holes formed in a flange at a bottom end of the tower. Then, washers and nuts are attached to the threaded ends of the anchor bolts in order to rigidly connect the tower to the foundation.

For towers subjected to high loads at the tower bottom, as in wind energy converters of high energy generating capacity, anchor bolt connections that provide the fixation of the tower to the foundation are subject to high fatigue loads, which may shorten the lifespan of the tower foundation, requiring the tower to be dismantled or placed on a new foundation at high cost.

### SUMMARY

One general aspect of the invention relates to a foundation fixing unit for fixing a tower of a wind energy converter onto a foundation. The unit comprises a fixation plate fixable to the foundation, walls forming at least one tower fixation hole in the fixation plate for passing a tower fixation bolt through the fixation plate in order to fix the tower to the fixation plate, a tower fixation nut arranged below the at least one tower fixation hole for receiving a threaded portion of the tower fixation bolt, and a nut cage holding the tower fixation nut, the nut cage being attached to a bottom surface of the fixation plate.

Because the tower is fixable to the fixation plate, and the fixation plate is fixable to the foundation, the inventive tower fixation unit enables fixation of the tower onto the foundation via the fixation plate. Because the tower fixation bolt that effects the fixation of the tower is received in the tower fixation nut below the fixation plate, which is held inside the nut cage, the tower fixation bolt may be removed, inspected and/or replaced even after erection of the tower when the underside of the intermediate plate is no longer accessible, thus enabling safe operation and maintenance over a long time even under very high fatigue load conditions typically observed in high-power wind energy converters.

Embodiments of this foundation fixing unit may include one or more of the following features.

The fixation plate comprises walls forming a plurality of foundation fixing holes for fixing the fixation plate onto the foundation. This enables e.g. to guide a corresponding plurality of protruding threaded ends of anchor bolts that are partially embedded in the foundation through the foundation fixing holes, such that the fixation plate can be fixed with great rigidity on top of the foundation. The fixation plate is in this way enabled to function as an intermediate plate arranged between the tower and the foundation.

For towers subjected to high loads at the tower bottom, as in wind energy converters of high energy generating capacity, it is desirable to distribute the load to avoid excessive pressure on the foundation. Commonly, this is achieved by using a T-flange, which extends both towards the outside and the inside of the tower. Two corresponding rows of anchor bolts, one inside and one outside the tower provide the fixation of the T-flange to the foundation.

For tubular towers, generally a higher strength-to-weight ratio, which leads to lower material cost, can be achieved by increasing the diameter at the tower bottom. However, the maximum outside diameter is limited by transportation issues in the typical case where prefabricated tower segments have to be transported from a manufacturing site to the erection site of the wind energy converter. For a tower equipped with a T-flange, the outward-extending portion of the T-flange defines the maximum outside diameter of the tower. The outside diameter of the tubular tower walls could in principle be increased by replacing the T-flange with an L-flange that from the lower end of the tubular tower walls extends only inwardly. However, a single row of anchor bolts positioned along the inside of the tower walls and guided through fixing holes in the L-flange would place the concrete foundation under excessive pressure.

By enabling to arrange the fixation plate as an intermediate plate between the tower and the foundation, the tower fixation bolt does not directly act on the foundation such as placing it under pressure when mechanical load is transferred by the tower e.g. due to wind.

Because the tower fixation bolt does not act directly on the foundation, arrangements of tower fixation bolts along a single row is enabled without causing excessive pressure on the foundation. For example, use of a flange such as an L-flange is enabled, which comprises only a single row of holes for guiding the tower fixation bolts through the flange. Consequently, a higher weight-to-strength ratio of the tower is achievable by choosing a larger tower diameter without exceeding a predetermined size restriction imposed e.g. by transportation.

Typically a size restriction imposed by transportation issues applies to a maximum value for the smallest of the three dimensions of an object along three orthogonal axes in space. Because the intermediate plate is plate-shaped, implying a thickness of the plate that is substantially less than its dimensions in the horizontal plane, the horizontal dimensions of the intermediate plate may be chosen to be greater than the predetermined size restriction. Thus, the intermediate plate may be dimensioned such that its fixation to the foundation distributes the load transferred by the tower, preventing excessive pressure on the foundation.

In some embodiments, the fixation plate comprises a plurality of tower fixation holes arranged along a substantially arc-shaped row. This enables to fix the fixation plate to a tower having a substantially tubular shape with particularly favorable strength-to-weight ratio.

The plurality of foundation fixing holes can be arranged along inner and outer rows that enclose in-between them the row of tower fixation holes. In other words, the inner row and the outer row are disposed on either side of the row of tower fixation holes. In this way, particularly strong fixation of the tower to the foundation is achieved.

In some embodiments, the intermediate plate comprises an annular or annular-section like shape. This enables the fixation plate to support a tower having a substantially tubular shape with particularly favorable strength-to-weight ratio with little material requirement due to the cut-out interior of the annulus. An annular-section shape enables a tower of substantially tubular shape to be supported by a combination of two or more such fixation plates arranged to combine into an annulus while enabling easy transportation of each fixation plate due to small size.

The nut cage can comprise a nut tube having a non-circular interior profile or cross section, which blocks rotation while permitting vertical translation of the nut. This enables the nut to move vertically while being held when the tower fixation bolt is screwed into the nut.

In some embodiments, the nut tube comprises a height 1.2 to 2 times greater than a height of the nut, e.g. about 1.5 times greater. This enables the tower fixation bolt, when chosen to have a suitable length that slightly exceeds the nut in fixed position, to reach the nut through the tower fixation hole when the nut is disconnected from the tower fixation bolt and rests at the bottom of the nut cage.

The interior cross section of the nut tube can comprise a pair of opposing walls separated by a distance that corresponds to a wrench size of the nut. That is, an imaginary line orthogonal to both walls and extending between them has a length that corresponds to the wrench size of the nut. This enables the nut tube to securely and precisely hold the tower fixation nut through surface-to-surface contact when receiving the tower fixation bolt and/or in case of removal of the tower fixation bolt, acting as a wrench of appropriate wrench size that exerts a torque on the nut for preventing it from rotating with the tower fixation bolt.

In some embodiments, the interior profile of the nut tube is rectangular. This enables cost-effective production of the foundation fixing unit due to a simple geometric shape having only four walls.

In some embodiments, the nut tube and the nut have the same profile. That is, the nut comprises an exterior profile corresponding to an interior profile of the nut tube, the exterior profile of the nut being slightly smaller than the interior profile of the nut tube to allow the nut to be located within the nut tube. This enables the nut tube to hold the tower fixation nut particularly securely and precisely when receiving the tower fixation bolt and/or removing the tower fixation bolt because surface-to-surface contact is established over a particularly large area along the circumference of the tower fixation nut.

In some embodiments, the interior profile of the nut tube is hexagonal in correspondence with a hexagonal exterior profile of the nut. This advantageously enables to use a conventionally available type of nut at low cost.

The nut cage can comprise a cover disc that covers a bottom end of the nut tube. This prevents undesired material such as water and/or grout from entering the nut tube, thus preventing corrosion and ensuring free movability of the tower fixation nut in the nut cage.

In some embodiments, the foundation fixing unit further comprises a washer held in the nut cage above the nut. This enables a particularly even load distribution between the tower fixation nut and the intermediate plate, such that damage to the tower fixation nut and the fixation plate is avoided and a particularly secure fixation achieved.

In some embodiments, the washer has an outer profile exceeding the interior profile of the nut tube, while the nut cage further comprises a washer tube above the nut tube for holding the washer. In this way, the washer is enabled to have a particularly large size and corresponding favorable load distribution. Furthermore, the washer is prevented from entering the nut tube and getting jammed within.

The nut cage can have an exterior sheathing comprising an elastomeric material, e.g. rubber or a rubber-like material. In this way, deformation and damage through exterior pressure on the nut cage by material such as grout or concrete surrounding the nut cage is prevented. Also, tension and cracks in the grout or concrete, which otherwise might arise from differences in temperature and ensuing differences in the thermal expansion state between the tower and the foundation, are prevented.

Another general aspect of the invention provides a wind energy converter comprising a foundation, the foundation fixing unit of any one of the preceding embodiments and a tower fixed onto the foundation using the foundation fixing unit.

Embodiments of this aspect may include one or more of the following features.

In some embodiments, the wind energy converter furthermore comprises anchor bolts, which fix the fixation plate as an intermediate plate onto the foundation. In this way, particularly strong fixation of the intermediate plate is enabled, while stresses on the foundation concrete are avoided.

The wind energy converter can further comprise an anchor plate embedded in the foundation, such that stresses are distributed also within the foundation, thus further avoiding excessive pressure.

The anchor plate may have an exterior shape substantially identical to the intermediate plate, resulting in distribution of stresses in the foundation over the entire area of the intermediate plate with minimal material requirement.

In some embodiments, the wind energy converter further comprises a layer of grout between the foundation and the intermediate plate. This enables to equalize unevenness in a foundation top surface and to adjust the position of the intermediate plate above the foundation such that a top Surface of the intermediate plate lies within a horizontal plane. Furthermore, accommodation of the nut cage within the grout layer is enabled, such that e.g. special preparation of an opening etc. to accommodate the nut cage in the foundation is unnecessary.

Another general aspect of the invention provides a method for fixing a tower of a wind energy converter onto a foundation. The method includes fixing a fixation plate having at least one tower fixation hole to the foundation. In further steps, a nut cage holding a tower fixation nut is attached to a bottom surface of the intermediate plate below the at least one tower fixation hole, a tower fixation bolt is passed through the tower fixation hole into the nut cage, and the tower is fixed to the fixation plate using the tower fixation bolt and the tower fixation nut.

Embodiments of this aspect may include one or more of the following features.

The fixing of the tower to the fixation plate is performed by screwing the tower fixation bolt into the tower fixation nut, providing a reliable and easily removable fixation between tower and fixation plate.

fixation plate to the foundation can be performed before the fixing of the tower to the fixation plate. In this way, the intermediate plate can be precisely aligned to the horizontal without the tower. This saves time for the tower erection.

In some embodiments, the fixing of the fixation plate onto the foundation is performed after the fixing of the tower to the fixation plate. This means that the fixation plate is pre-assembled to the tower and later on the tower with the already connected fixation plate is assembled to the foundation.

Other features and advantages are illustrated in the accompanying drawings and described in detail in the following part of the description.

### FIGURES

In the Figures:

FIG. 1 is a schematic illustration of a wind energy converter according to an embodiment of the invention, the wind energy converter having a tower fixed onto a foundation via a tower fixation unit including an intermediate plate with nut cages;

FIG. 2 is a cross-sectional detail view of the wind energy converter of FIG. 1, showing the fixation of the tower onto the foundation by means of a tower fixation unit according to an embodiment and a method according to embodiment;

FIG. 3 is a schematic cross-section detailing a nut cage of a tower fixing unit according to an embodiment, comprising a tower fixation nut at rest in the nut cage;

FIG. 4 is a schematic cross-section of the nut cage of FIG. 3, with a tower fixation bolt screwed into the tower fixation nut;

FIG. 5 is a schematic top view of a foundation fixing unit according to an embodiment, for fixing a tower of a wind energy converter onto a foundation; and

FIG. 6 is a cross-sectional detail view showing the fixation of a tower of a wind energy converter onto the foundation by means of a tower fixation unit according to a further embodiment.

Throughout the figures, the same reference numbers indicate the same or functionally equivalent means.

### DETAILED DESCRIPTION

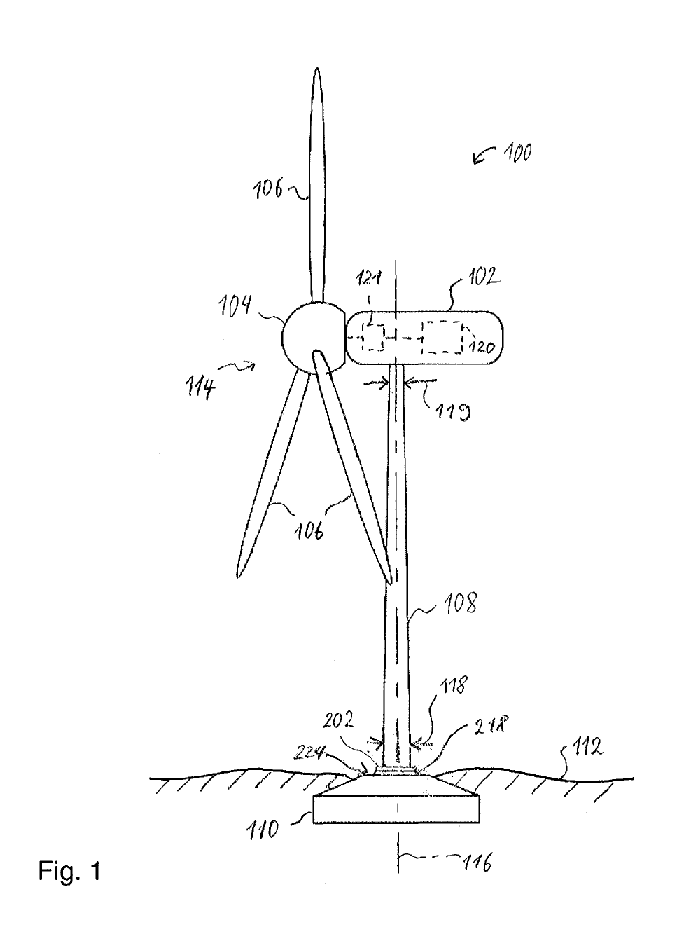

FIG. 1 is a schematic illustration of a wind energy converter 100, which includes a rotor 114 having a number of rotor blades 106 that extend radially from a hub 104. The hub 104 is rotatably mounted on a nacelle 102, which houses a generator 120 for generating electricity, when driven by the rotor 114 directly or via a gear train 121, shown as an example.

The nacelle 102 is rotatably mounted on a tubular steel tower 108 that is fixed onto a concrete foundation 110, which is embedded in soil 112 in order to transfer loads received from the tower 108 to the earth. The tower 108 is of approximately conical outward shape centered on a vertical symmetry axis 116, its outer diameter gradually tapering off from a maximum diameter 118 close to the foundation 110 to a minimum diameter 119 close to the nacelle 102. For optimum strength-to-weight ratio of the tower 108, a large value of the maximum diameter 118 is desirable. For ease of transportation to the erection site of the wind energy converter 100, the tower 108 may be divided horizontally into two or more segments of tubular shape. In order to enable economical transportation of the tubular segments of the tower by conventional means of transportation such as roads, railways, etc., the maximum diameter 118 of the tower 108 is configured to correspond to a size limit imposed by the chosen means of transportation, e.g. 4.3 m in case of conventional road transportation that involves passage below bridges.

The tower 108 is fixed onto the foundation 110 by means of a foundation fixing unit that includes a fixation plate provided as an intermediate plate 202 arranged horizontally between the tower 108 and the foundation 110. The intermediate plate 202 is fixed onto the foundation 110, an adjustment gap 224 filled with a layer of grout 218 being provided between the foundation 110 and the intermediate plate 202. The adjustment gap 224 enables horizontal alignment of the intermediate plate 202 on the top surface of the foundation 110, which after casting may not be sufficiently even and horizontal to directly support the intermediate plate 202. The tower 108 is fixed onto the intermediate plate 202, thus resulting in indirect fixation of the tower 108 onto the foundation 110 via the intermediate plate 202.

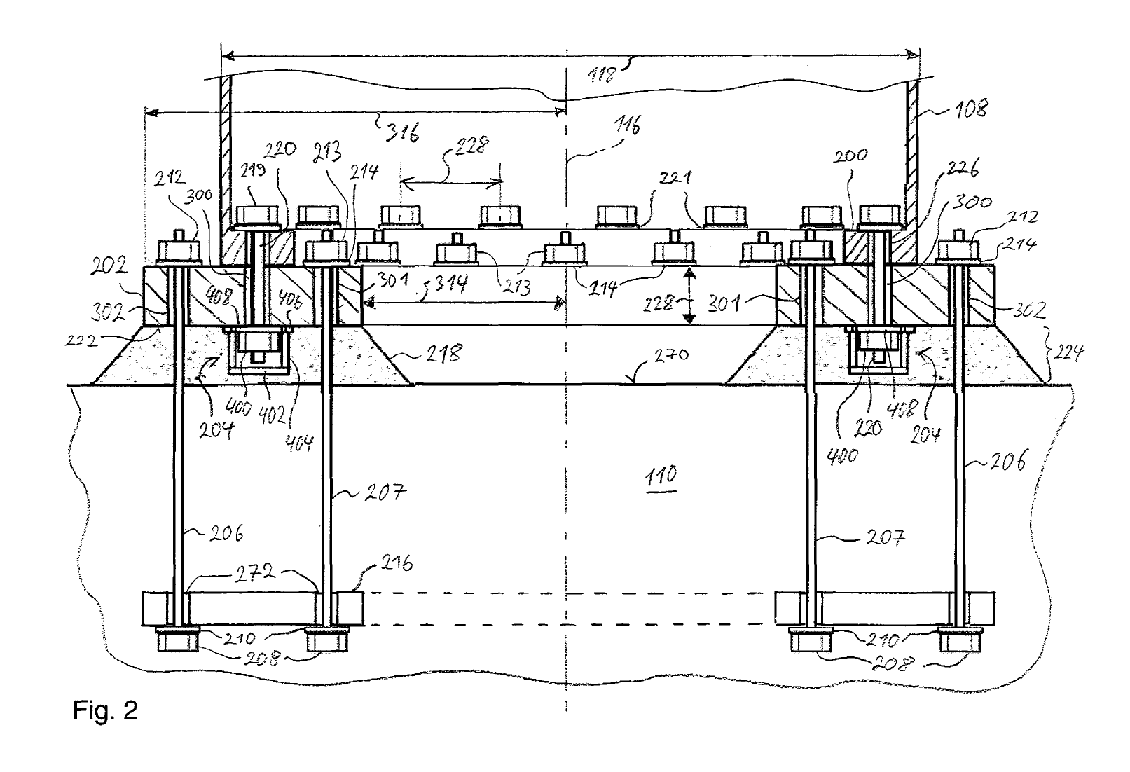

The fixation of the tower 108 onto the foundation 110 shall now be explained in further detail by making reference to FIG. 2, which shows a cross-section taken along the symmetry axis 116 of the tower 108, detailing a bottom portion of the tower 108, the intermediate plate 202, the grouting layer 218, and a top portion of the foundation 110 of FIG. 1. The tower 108, i.e. a bottom segment of the tower 108 in case of a horizontally segmented tower, is shown to comprise at its lower end an inward-facing L-flange 200. Because the L-flange 200 is facing inwards, its horizontal width does not add to the maximum diameter 118 of the tower 108. In the L-flange 200, vertically extending through-holes 226 are formed in regular intervals 228 along the diameter of the tower 108 within its tubular walls.

The intermediate plate 202, which has a constant thickness 228, is preferably formed of steel. As can be seen in FIG. 2, a bottom side of the L-flange 200 rests on the intermediate plate 202, with tower fixation holes 300 for fixing the tower 108 onto the intermediate plate 202 extending vertically through the intermediate plate 202, coinciding with the through-holes 226 that are formed in the L-flange 200. In the horizontal plane, i.e. when viewed from above in the direction of the tower axis 116, the intermediate plate 202 exhibits an annular shape, each of the tower fixation holes 300 being equally distanced from an inner 314 and outer 316 radius of the annulus.

Centered below each tower fixation hole 300, a nut cage 204, which encloses an associated tower fixation nut 400 and washer 408, is attached to a bottom surface 222 of the intermediate plate 202. The intermediate plate 202 together with the attached nut cages 204 and the associated tower fixation nuts 400 and washers 408 contained therein form a foundation fixing unit 202, 204, 400, 408 by means of which the tower 108 is fixed onto the foundation 110.

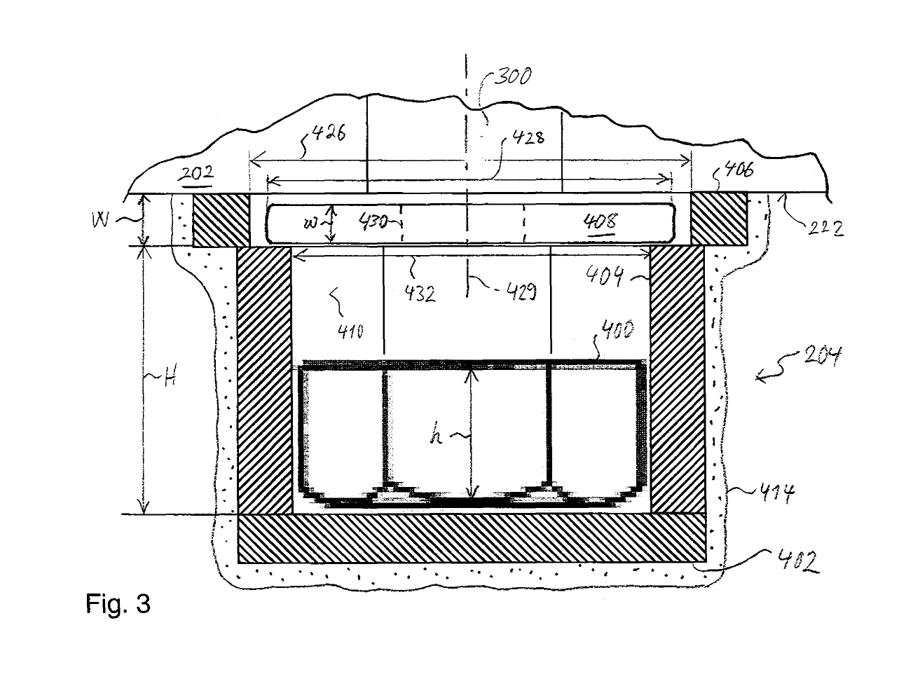

FIG. 3 shows an enlarged cross section through a portion of the intermediate plate 202, which includes the opening of one of the tower fixation holes 300 into the bottom surface 222 of the intermediate plate 202, and the corresponding nut cage 204 attached to the intermediate plate 202 below the tower fixation hole 300.

The nut cage 204 includes a washer tube 406 of cylindrical shape in which the washer 408 is contained. The washer tube 406 is attached, e.g. by welding, to the bottom surface 222 of the intermediate plate 202, centrally positioned on a symmetry axis 429 of the tower fixation hole 300. The washer 408 is a thin, disc-shaped plate with a circular hole 430 in the middle. The washer tube 406 has an inner diameter 426 that is larger than an outer diameter 428 of the washer 408 by such an amount of clearance that the washer 428 is allowed to slightly move horizontally in the washer tube 406 while being sufficiently restricted to ensure that the washer hole 430 substantially overlaps the tower fixation hole 300. Similarly, the washer tube 406 has an inner height W that is larger than a thickness w of the washer 408 by such an amount of clearance that the washer 428 is allowed to slightly move horizontally in the washer tube 406 while being sufficiently restricted to ensure that the washer hole 430 substantially overlaps the tower fixation hole 300.

The nut cage 204 further includes a nut tube 404 of hexagonal inner and outer profiles, centered on the symmetry axis 429 of the tower fixation hole 300, in which the tower fixation nut 400 is contained. The inner hexagonal profile of the nut tube 404 is chosen to be slightly wider than a hexagonal outer profile of the tower fixation nut 400, such that the nut 400 is easily movable within the nut tube 404 in the vertical direction along the symmetry axis 429 while being prevented from rotation and tilting with respect to the symmetry axis 429. In other words, the distance of diametrically opposing walls 410 of the inner hexagonal profile of the nut tube 404 corresponds to a wrench size of the tower fixation nut 400. The nut tube 400 has a height H that is about 1.2 to 2.0 times higher than a height h of the tower fixation nut 400 and is closed off at its bottom end by a welded-on lid 402.

At its top end, the nut tube 404 is welded to the bottom end of the washer tube 406. The welding connections between the intermediate plate 202, the washer tube 406, the nut tube 404, and the lid 402 are performed without gaps such that the nut cage 204 is open only to the tower fixation hole 300. The outer diameter 428 of the washer 408 is chosen such that the washer 408 is prevented from entering the nut tube 404. For example, the outer diameter 428 of the washer 408 is configured to be greater than the distance 432 between opposing corners of the inner profile of the nut tube 404, preferably by at least half the difference between the outer diameter 428 of the washer 408 and the inner diameter 426 of the washer tube 406.

At its outside, the nut cage 204 comprises a rubber armoring 414, which provides an elastic buffer zone between the nut cage 204, which is made e.g. of steel, and surrounding material such as the grout layer 218 shown in FIG. 2.

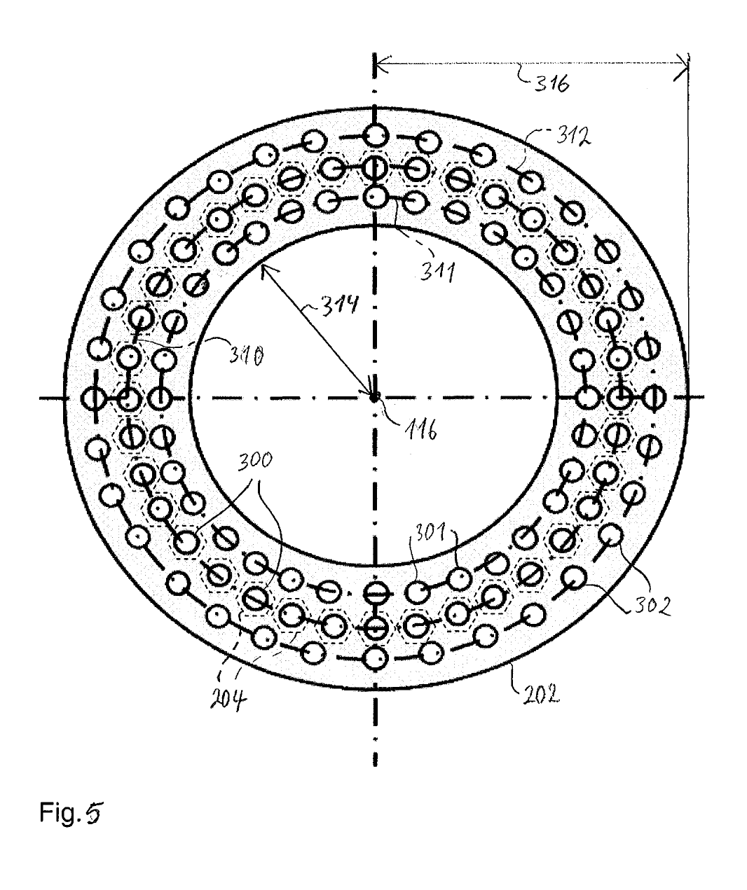

FIG. 5 shows is a schematic top view of a foundation fixing unit, which includes an intermediate plate 202 having an annular shape with an inner radius 314 that is smaller than a bottom radius of a corresponding tower to be fixed onto a foundation, and an outer radius 316 that is larger than the bottom radius of the tower. A plurality of equally spaced tower fixation holes 300 is formed in a central circular row 310 around the annulus, which runs midway between the inner 314 and outer 316 radii. Hexagonal nut cages 204 containing nuts and washers (not shown) are attached to the intermediate plate 202 below each tower fixation hole 300.

Furthermore, a plurality of inner 301 and outer 302 foundation fixing holes are formed in the intermediate plate 202, the inner 301 and outer 302 foundation fixing holes each being equally spaced along corresponding inner 311 and outer 312 circular rows. All three circular rows 310-312 are concentric around the symmetry axis 116 of the intermediate plate 202, which coincides with the symmetry axis of the tower to be fixed.

The fixation of an intermediate plate 202 such as shown in FIG. 5 to a foundation 110 shall now be explained by making reference again to FIG. 2 wherein an intermediate plate 202 is shown that, apart from having fewer tower fixation holes 300 and foundation fixing holes 301, 302 than the intermediate plate 202 of FIG. 5, is of substantially equivalent design.

Within the foundation 110, two concentric rows of inner 206 and outer 207 anchor bolts are partially embedded in the concrete, threaded portions thereof projecting vertically from a top surface 270 of the concrete foundation 110. For additional strength, an annular anchor plate 216 made from steel is embedded in the foundation, having substantially half the thickness and identical inner 314 and outer 316 radii as the intermediate plate 202. In the anchor plate 216, through holes 272 are formed coincidently with the foundation fixing holes 301, 302 in the intermediate plate 202.

When preparing the foundation 110, each anchor bolt 206, 207 is guided, bolt head 208 facing downward, through an associated washer 210 and one of the through holes 272 formed in the anchor plate 216. Afterwards, and possibly after additional steel reinforcements have been positioned, the concrete of the foundation 110 is cast. After hardening of the concrete foundation 110, the threaded ends of the anchor bolts 206, 207 are each guided through a corresponding one of the foundation fixing holes 301-302 of the intermediate plate 202. The intermediate plate 202 is then supported in horizontal alignment above the foundation 110, leaving a gap 224 between its bottom surface 22 and the foundation, the nut cages 204 being suspended in the gap 224 without touching the foundation 110.

After aligning the intermediate plate 202, the gap 214 is filled with grouting concrete, creating a grouting layer 218 in which each nut cage 204 is immersed. After the grouting layer 218 has hardened, the intermediate plate 202 is fixed to the inner 207 and outer 206 anchor bolts by screwing corresponding inner 213 and outer 212 anchor bolt nuts equipped with associated anchor bolt nut washers 214 onto the threaded ends of each anchor bolt 206-207.

The fixation of the tower 108 to the intermediate plate 102 may be performed either before or after fixing the intermediate plate 202 to the foundation 110. After the tower 108, or the bottommost tower segment in case of a segmented tower, has been brought into contact and alignment with the intermediate plate 202 such that each through hole 226 formed in the L-flange 200 coincides with a corresponding tower fixation hole 300 formed in the intermediate plate 202, for each tower fixation hole 300 a tower fixation bolt 220 is guided first through an associated tower fixation bolt washer 221, then through an associated through hole 226 formed in the L-flange, and finally through the tower fixation hole 300 into the associated nut cage 204 attached to the intermediate plate below the tower fixation hole 300 until a threaded portion at the tip of the tower fixation bolt 220 contacts the tower fixation nut 400 contained in the nut cage 204.

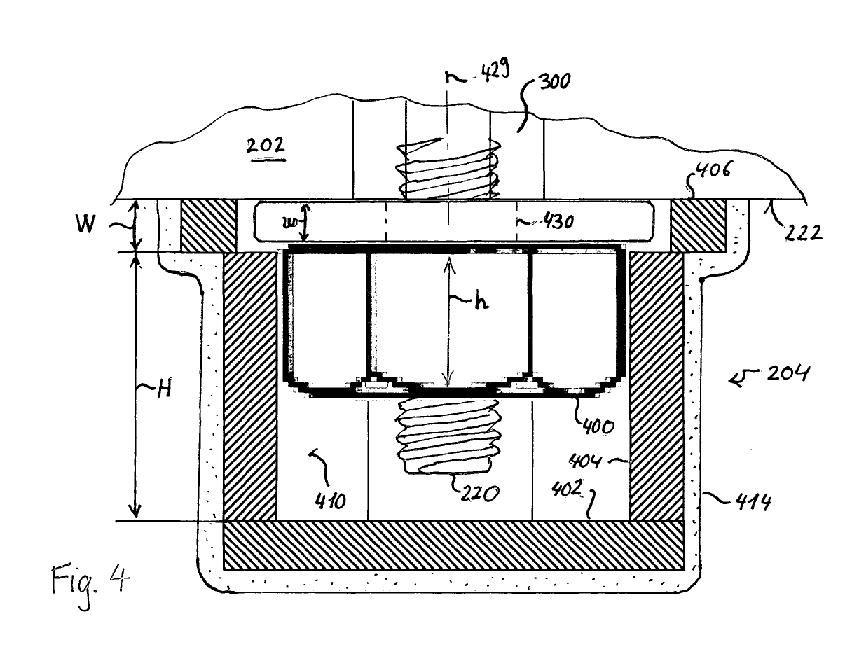

Then, the tower fixation bolt 220 is screwed by turning its head 219, using a suitable wrench, into the tower fixation nut 400. The nut 400, which is blocked from rotation by the surrounding nut tube 404, gradually rises from the bottom lid 402 of the nut cage 204 towards the intermediate plate 202, eventually partially entering the washer tube 406 and pressing the washer 408 against the bottom surface 222 of the intermediate plate 202. The resulting positions of the tower fixation bolt 220, tower fixation nut 400 and tower fixation nut washer 430 in a state where the tower is fixed to the intermediate plate 202 are shown in FIG. 4.

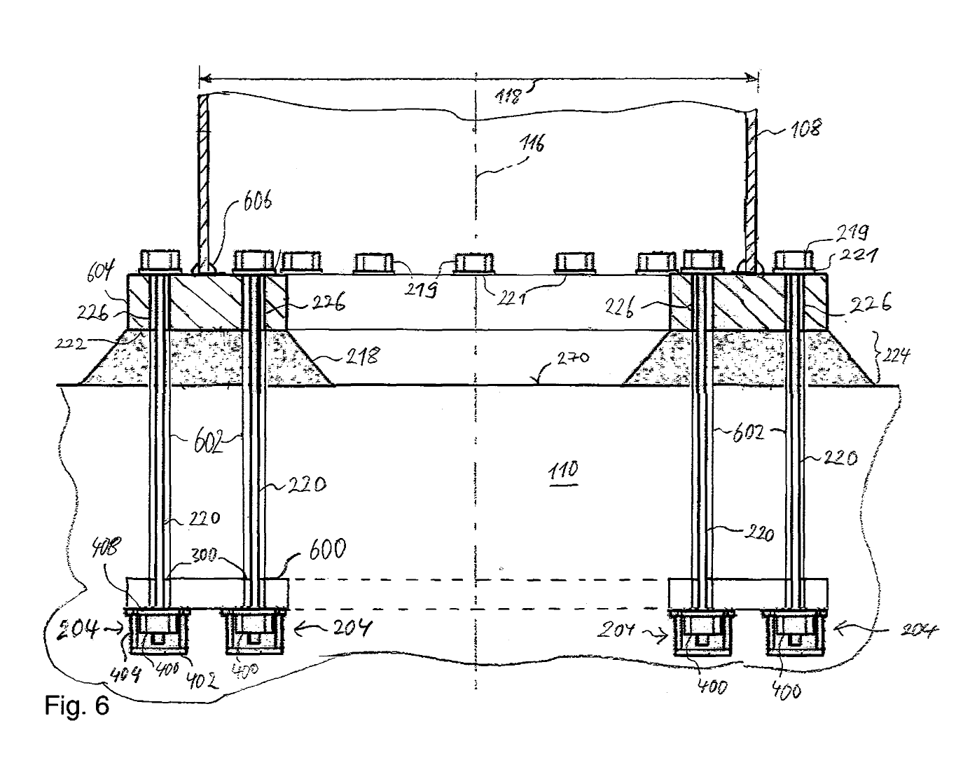

FIG. 6 illustrates the fixation of a tower of a wind energy converter onto its foundation by means of a further tower fixation unit 600, 204, 400, which includes a fixation plate 600 formed as an anchor plate 600 with nut cages 204 attached to a bottom surface thereof, below tower fixation holes 300 formed in the fixation plate 600. The fixation plate 600 is fixed to the foundation 110 by embedding in the wet concrete during foundation 110 casting. Furthermore embedded in the foundation 110 are tower fixation bolt pipes 602, which extend upwardly from the openings of the tower fixation holes 300 through the foundation 110 and a grout layer 218 formed on top of the foundation 110. The tower fixation bolt pipes 602 comprise an interior width approximately corresponding to the interior width of the tower fixation holes 300. The tower fixation bolt pipes 602 may be welded to the fixation plate 600.

The tower 108 includes an annular T-flange 604 welded 606 to a bottom end thereof. In the T-flange, the annular shape of which corresponds to an annular shape of the fixation plate 600, two rows of through-holes 226 are formed to coincide with the tower fixation holes 300. In order to attach the tower 108 to the foundation 110, tower fixation bolts 200 have each been guided through an associated washer 221, one of the through-holes 226 formed in the T-flange, a tower fixation bolt pipe 602, and a tower fixation hole 300 into one of the nut cages 204, and subsequently screwed into the nut 400 held therein.

The embodiments described above can be varied in multiple ways. For example, the embodiments of FIG. 2 and FIG. 6 may be combined by adding nut cages to the anchor plate 216, forming the connection between the anchor plate 216 and the intermediate plate 202 substantially like the connection between the fixation plate 600 and the flange 604 in the embodiment of FIG. 6. Also, a nut tube may be provided having a quadrangular, in particular rectangular cross section, wherein the smaller inside diameter of the nut tube is slightly bigger than the wrench size of the tower fixation nut and the larger inside diameter is slightly bigger than the width across corners of the nut. Or, a nut cage may be provided that does not contain a washer. The nut tube may be connected directly to the fixation plate without a washer tube being present in-between. Generally, the nut cage may be constructed monolithically without welding connections, or from an arbitrary number of parts. Also, instead of being shaped as a full annulus, the intermediate plate may be configured in two or more sectional parts. Other embodiments are within the scope of the following claims.

1. A foundation fixing unit for fixing a tower of a wind energy converter onto a foundation, said unit comprising:
a fixation plate fixable to the foundation;
walls forming at least one tower fixation hole in the fixation plate for passing a tower fixation bolt through the fixation plate in order to fix the tower to the fixation plate;
a tower fixation nut arranged below the at least one tower fixation hole for receiving a threaded portion of the tower fixation bolt; and
a nut cage holding the tower fixation nut, the nut cage being attached to a bottom surface of the fixation plate.

2. The foundation fixing unit of claim 1, wherein the fixation plate comprises walls forming a plurality of foundation fixing holes for fixing the fixation plate onto the foundation.

3. The foundation fixing unit of claim 1, wherein the fixation plate comprises walls forming a plurality of tower fixation holes arranged along a substantially arc-shaped row.

4. The foundation fixing unit of claim 2, wherein the plurality of foundation fixing holes is arranged along inner and outer rows, the inner and outer row being disposed on either side of a row of tower fixation holes.

5. The foundation fixing unit of claim 1, wherein the fixation plate comprises an annular or annular-section shape.

6. The foundation fixing unit of claim 1, the nut cage comprising a nut tube having a non-circular interior cross section, which blocks rotation while permitting vertical translation of the nut.

7. (canceled)

8. The foundation fixing unit of claim 6, wherein the interior cross section of the nut tube comprises a pair of opposing walls separated by a distance that corresponds to a wrench size of the nut.

9. (canceled)

10. (canceled)

11. (canceled)

12. The foundation fixing unit of claim 6, wherein the nut cage further comprises
a cover disc that covers a bottom end of the nut tube.

13. The foundation fixing unit of claim 1, further comprising a washer held in the nut cage above the nut.

14. The foundation fixing unit of claim 13,
wherein the washer has an outer profile exceeding the interior profile of the nut tube, and
wherein the nut cage further comprises a washer tube above the nut tube for holding the washer.

15. The foundation fixing unit of claim 1, wherein the nut cage has an exterior sheathing having an elastomeric material.

16. A wind energy converter comprising:
a foundation;
a foundation fixing unit having a fixation plate fixable to the foundation; walls forming at least one tower fixation hole in the fixation plate for passing a tower fixation bolt through the fixation plate in order to fix the tower to the fixation plate; a tower fixation nut arranged below the at least one tower fixation hole for receiving a threaded portion of the tower fixation bolt; and a nut cage holding the tower fixation nut,
the nut cage being attached to a bottom surface of the fixation plate; and
a tower fixed onto the foundation using the foundation fixing unit.

17. The wind energy converter of claim 16, wherein the tower comprises an inward-facing L-flange at a lower end thereof, the L-flange being fixed onto the fixation plate.

18. The wind energy converter of claim 16, furthermore comprising anchor bolts fixing the fixation plate onto the foundation.

19. The wind energy converter of claim 18, further comprising an anchor plate embedded in the foundation.

20. (canceled)

21. The wind energy converter of claim 16, further comprising a layer of grout between the foundation and the fixation plate.

22. A method for fixing a tower of a wind energy converter onto a foundation, said method comprising:
fixing a fixation plate having at least one tower fixation hole to the foundation;
attaching a nut cage holding a tower fixation nut to a bottom surface of the fixation plate below the at least one tower fixation hole;
passing a tower fixation bolt through the tower fixation hole into the nut cage; and
fixing the tower to the fixation plate using the fixation bolt and the tower fixation nut

23. The method of claim 22, wherein fixing the tower to the fixation plate comprises screwing the fixation bolt into the tower fixation nut.

24. (canceled)

25. The method of claim 22, wherein fixing the fixation plate with the foundation is performed after fixing the tower to the fixation plate.

26. The method of claim 22, further comprising grouting a gap between the foundation and the fixation plate.
